(19) United States
(12) Patent Application Publication
(10) Pub. No.: US 2009/0171628 A1
(43) Pub. Date: Jul. 2, 2009

(54) PLANNING A SENSOR ARRAY IN ACCORDANCE WITH TEMPO-SPATIAL PATH ESTIMATION OF POTENTIAL INTRUDERS

(76) Inventors: Shay PERETZ, Shimshit (IL); Dror Ouzana, Haifa (IL); Ittal Bar-Joseph, Shimshit (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/967,604

(22) Filed: Dec. 31, 2007

(51) Int. Cl. G06F 17/50; G06F 17/12

(52) U.S. Cl. 703/1; 703/2

(57) ABSTRACT

A computerized method and system for providing a user with at least one scenario in a modeled theater. The computerized method may include the following steps: a) selecting a plurality of threat-sites in the modeled theater, wherein the threat-site comprises at least one of the following: at least one threat-area, and at least one threat object; b) selecting at least one secured-site in the modeled theater, wherein the secured-site is at least one of the following: at least one secured-area, and at least one secured-object; c) providing at least one constraint parameter; and d) determining the at least one penetrating scenario. The penetrating scenario may pertain to at least one of the following: the position and shape of at least one penetrating route.

### FIELD OF INVENTION

The present invention relates to the field of surveillance planning systems and methods. More specifically, the present invention relates to the field of planning routes within a secured site covered by a surveillance system, using computer based architecture.

### BACKGROUND OF INVENTION

The planning of multiple routes for mobile dynamic force-tasks becoming increasingly dependent on intelligent systems to guide the designing of security architectures and planning of mission tasks. The demand for comprehensive security solutions involving advanced technology is rapidly increasing, thereby constituting the need for a robust decision support computer-based framework.

In many planning applications, the planning process is preceded by a pre-processing stage in which the entire area is partitioned to multiple area cells. Then, an iterative process is applied in which the highest point in each area cell is determined in view of its adjacent area cells. Thus a map containing the highest points in each cell as well as the area covered by each highest point. Similarly a map containing the obscured areas may also be prepared.

### SUMMARY OF SOME EMBODIMENTS OF THE INVENTION

The present invention discloses a computerized method and system that supports the evaluating of penetrating routes into a secured site.

In embodiments of the invention, the computerized method and system provides a user with at least one scenario in a modeled theater.

In embodiments of the invention, the computerized method includes the step of selecting a plurality of threat-sites in the modeled theater, wherein the threat-site comprises at least one of the following: at least one threat-area, and at least one threat object.

In embodiments of the invention, the computerized method includes the step of selecting a plurality of secured-sites in the modeled theater, wherein the secured-site comprises at least one of the following: at least one secured-area, and at least one secured object.

In embodiments of the invention, the computerized method includes the step of selecting a plurality of covered-areas in the modeled theater, wherein the covered-area may be constituted by the area covered by a surveillance system.

In embodiments of the invention, the computerized method includes the step of selecting a plurality of penetrators in the modeled theater, wherein the penetrator comprises at least one penetrating object.

In embodiments of the invention, the computerized method includes the step of providing at least one constraint parameter.

In embodiments of the invention, the computerized method includes the step of determining the at least one penetrating scenario, the penetrating scenario pertaining to the evaluating of at least one penetrating route into a secured site.

In embodiments of the invention, the determining the at least one scenario is accomplished based on computational analysis of at least one of the following: geographical information data, gathered data, penetrator data, and user input data.

In embodiments of the invention, the computational analysis includes the evaluating of one or more penetrating routes within a secured site for at least one penetrator.

In embodiments of the invention, the computerized method comprises the step of schematically illustrating the at least one scenario on an output unit.

In embodiments of the invention, the at least one of the scenarios provides optimized penetrating route within the plurality of secured-sites out of all possible scenarios that are determinable by taking into account the at least one penetrator parameter, followed by one or more constraint parameters.

In embodiments of the invention, a plurality of scenarios is presented to the user in an order that corresponds to the penetrating route properties of at least one penetrator.

In embodiments of the invention, the at least one constraint parameter further indicates at least one of the following: penetrator type; penetrator speed, indicating average and maximum speed; penetrator traversability, indicating the effecting magnitude of a traversability level on a given penetrator; penetrator maximum traversability threshold indicating the maximum traversability threshold of a given penetrator; slope level, indicating the effecting magnitude of a slope level on a given penetrator; maximum slope level, indicating the maximum threshold of a slope for a given penetrator; road factor, indicating the effecting magnitude of a road on the speed of a given penetrator.

In embodiments of the invention, the computational analysis comprises at least one of the following: image analysis and geometrical analysis. In embodiments of the invention the at least one distinct weighing factor is assigned to each corresponding parameter constraint for determining the order according to which each parameter constraint is to be taken into consideration for determining the constraint.

In embodiments of the invention, a penetrating route is defined by simulating the progression of a real object along at least one path in the real terrain within a certain time interval “t”, by means of a virtual object in the modeled theater.

In embodiments of the invention, the at least one scenario is selectably view able from various angles in a successive and simultaneous manner.

In embodiments of the invention, the computerized method comprises the step of recording a frame of the at least one scenario and schematically displaying the at least one frame.

In embodiments of the invention, the computerized method comprises the step of issuing a report comprising data about the at least one scenario.

In embodiments of the invention, the report is issued in at least one of the following formats: an HTML file format, a spreadsheet format, an image format a GIS format such as ShapeFile and GeoImages and a CAD format such as DXF.

Furthermore, the present invention discloses a computer-aided security design system that enables providing a user with at least one scenario in a modeled theater.

### BRIEF DESCRIPTION OF THE DRAWINGS

These and further features and advantages of the invention will become more clearly understood in the light of the ensuing description of a some embodiments thereof, given by way of example only, with reference to the accompanying figures, wherein:

FIG. 1 is a schematic block diagram illustration of the data flow in a computer-aided security design system, according to some embodiments of the invention;

FIG. 2 is a flow chart of a simple planning method implemented by the computer-aided security design system of FIG. 1, according to some embodiments of the invention;

FIG. 3 is a schematic illustration of a model of a real theater and the position of at least one sensor therein, according to some embodiments of the invention;

FIG. 4 is another schematic illustration of a model of a real theater and the evaluating of at least one penetrating route, according to some embodiments of the invention;

FIG. 5 is another schematic illustration of a model of a real theater wherein at least one penetrating route has been evaluated, according to some embodiments of the invention;

The drawings taken with description make apparent to those skilled in the art how the invention may he embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among tile figures to indicate identical elements.

### DESCRIPTION OF SOME EMBODIMENTS OF THE INVENTION

According to some embodiments of the invention, a computer-aided security design system (hereinafter referred to as “CASD system”) and method enables determining a security scheme that may pertain to, for example, the penetrating route of one or more penetrators into a secured site. According to some embodiments of the invention, a CASD system may evaluate optimal penetrating route based on scenario constraints, for one or more penetrators.

According to some embodiments of the invention, the CASD system determines the penetrating route according to computational analysis of theater data (such as terrain data [symbol] [symbol] [symbol] ), secured-site data, and penetrator data. The computational analysis includes the evaluating of a penetrating route of a penetrator into a secured-site using the expansion of a simulated three-dimensional temporal bubble progressing from threat-site to secured site and from secured-site to threat-site.

Correspondingly, the CASD system stores therein, inter alia, geographical information (GI) data of the theater (hereinafter referred to as “theater data”) and enables a user to provide the CASD system with inputs such as, for example, coordinates of a threat-site such as coordinates of a threat-area and threat-object; the coordinates, images and coverage area of a secured-site; penetrator parameters such as traversability level, slopes effect level and penetrator speed on various roads; scenario constraints such as maximum duration over which the secured site may be penetrated.

According to some embodiments of the invention, the CASD system may display on a two-dimensional display a virtual three-dimensional (3D) model of a theater according to at least some of the GI data and may schematically display in the virtual theater a security scenario schematically illustrating, for example, a penetrating route within a covered area surrounding the secured site. According to some embodiments of the invention, the location of the penetrating route may be optimized with regard to penetrator traversability such as, for example, level of traversability within a given secured-area, time duration for interception and the like.

Accordingly, the CASD system may be beneficial in establishing an effective defense and/or attacking plan and the like for any theater and/or site and/or area involved.

It should be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It should be understood that the phraseology and terminology employed herein is not to be construed as limiting and is for descriptive purpose only.

The principles and uses of the teachings of the present invention may be better understood with reference to the accompanying description, figures and examples.

It should be understood that the details set forth herein do not construe a limitation to an application of the invention. Furthermore, it should be understood that the invention can be carried out or practiced in various ways and that the invention can be implemented in embodiments other than the ones outlined in the description below.

It should he understood that the terms “including”, “comprising”, “consisting” and grammatical variants thereof do not preclude the addition of one or more components, features, steps, integers or groups thereof and that the teems are not to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and characteristics of the claimed composition, device or method.

If the specification or claims refer to “an additional” element, that does not preclude there being more than one of the additional element.

It should be understood that where the claims or specification refer to “a” or “an” element, such reference is not to be construed as there being only one of that element.

It should be understood that where the specification states that a component, feature, structure, or characteristic “may”, “might”, “can” or “could” be included, that particular component, feature, structure, or characteristic is not required to be included.

Where applicable, although state diagrams, flow diagrams or both may he used to describe embodiments, the invention is not limited to those diagrams or to the corresponding descriptions. For example, flow need not move through each illustrated box or state, or in exactly the same order as illustrated and described.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only,

Meanings of technical and scientific terms used herein ought to be commonly understood as by one of ordinary skill in the art to which the invention belongs, unless otherwise defined.

The present invention can be implemented in the testing or practice with methods and materials equivalent or similar to those described herein.

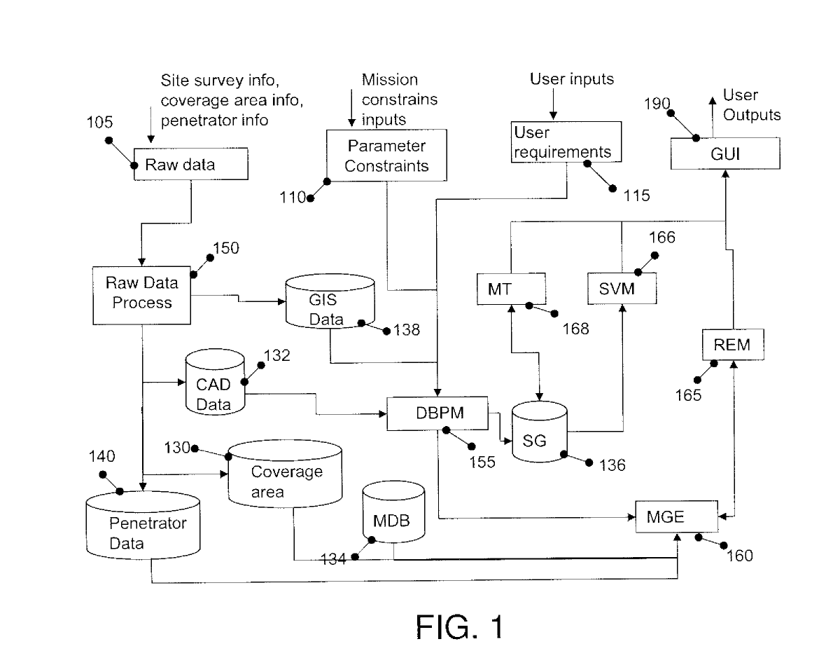

Reference is now made to FIG. 1. A CASD system may receive raw data 105 that may represent of site survey info comprising GI data and/or construction data (CAD) and/or coverage area of secured site data and/or penetrator data, may be processed 150 and may be stored in relevant databases 138, 132, 130 and 140 respectively. Survey GI data may represent, for example, surface elevation data, locations of objects (e.g. trees, rocks, buildings, telecommunication infrastructure and the like). A Data Base Pre-process Module (DBPM) 155 may fetch data from the GI database 138, CAD database 132 and/or from the coverage area database 130. The fetched data may then be stored in a Scene Graph (SG) database 136 that enables optimized graphical capabilities, which may be needed during route evaluation processes conducted by, a route evaluation module (REM) 165. The REM 165 may utilize a mathematic geometric engine (MGE) 160 or any other suitable engine. MGE 160 enables the generation of geometric data by using algorithms that enable solving optimization tasks and decision problems derived from said route planning. The algorithms used by MGE 160 may use a mathematical database (MDB) 134, which, in turn, enables access to relevant data during calculation processes and analysis phases. A virtual 3D theater is modeled and displayed on the GUI device 190, which may be, for example, a liquid crystal computer monitor screen. Once all relevant raw data are processed, a Simulation Visualization Module (SVM) 166 nay provide a graphic simulation of a specific scenario in the theater, the scenario being instantiated by mission constraints data 110 and specific user requirements 115.

Scenario simulation may be manipulable (i.e., scenario simulation may be modified and/or adapted and/or adjusted) by, e.g., a user via a suitable Modeling Tool (MT) 168. MT 168 enables the user, for example, to add, remove and modify objects displayed in the modeled theater. For example, the user may add and/or remove and/or alter the shape of, e.g., trees, rocks, buildings, barriers, fences, compounds, hills, and the like. The MGE 160 may be adapted to provide geometrical analysis of the site data for testing the effects on the evaluated penetrating route.

As already mentioned hereinabove, the user can provide the CASD system with inputs of various types of scenario alternatives, wherein the CASD system generates in return at least one solution.

In general, the REM 165 generates alternative penetrating routes to a secured area, based on GI data, CAD data, penetrator data, scenario constraints and the like. A secured area may consist of a secured site or object, surrounded by a coverage area. A coverage area may be regarded as the surface covered by one or more surveillance systems, such as, for example sensors. A penetrating route nay consist of a continuum curved line, connecting one or more sites and placed on a curved surface, which in turn, representing the geographical terrain. The REM evaluates the alternative penetrating routes, using a 3D simulated bubble, wherein, the simulated bubble's center is placed on the origin site's coordinates and than expanded through radius increase. The route is constructed, along with the bubble expansion, wherein each point on the bubble surface may be added to a relevant alternative route, creating a continuum curve. During said radius expansion, each alternative route consisting of a continuum curve is compared with scenario constraints and prioritized accordingly. Bubble expansion process is completed once bubble surface congruent with any of the target points. Alternatively, or additionally, said expansion process is completed once bubble surface is no longer congruent to any of the destination area surface, but were congruent in any of the previous expansion steps.

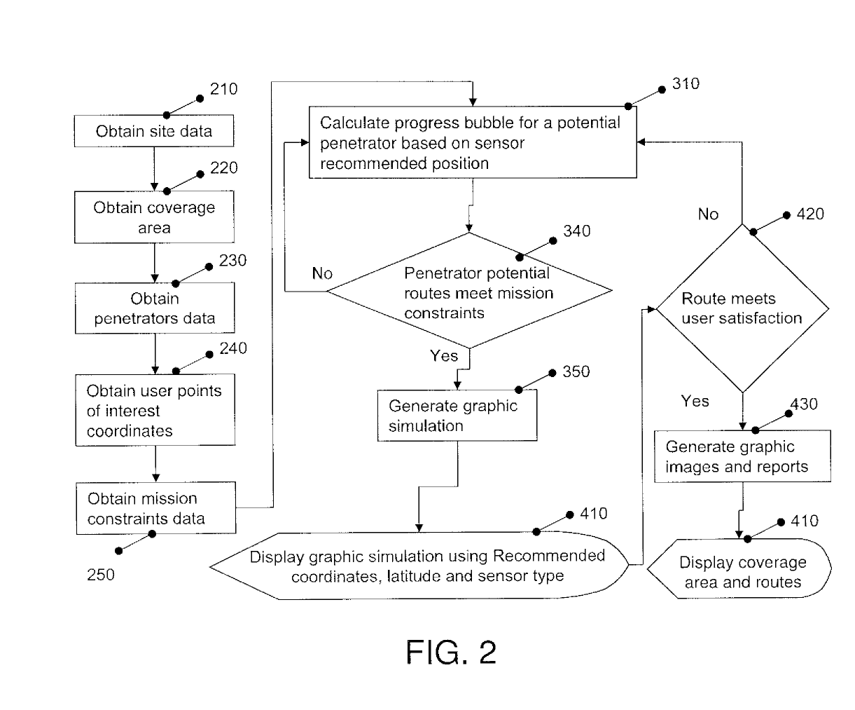

Reference is now made to FIG. 2. In an embodiment of the invention, the REM may execute a route evaluating method that may determine, for example, the optimal position and shape of one or more penetrating routes on a real theater and may display a map that schematically indicates the location of said route(s) in the real theater, and the like. A method of determining the optimal position of the routes may include the step of obtaining GI data 210. The GI data 210 may represent, for example, information about entities in the real theater (e.g., shape and/or location of a house, a hill, a rock, a building and the like), and the graphical representation of the same terrain when the entity is virtually removed, such as in response to a suitable user input.

According to some embodiments of the invention, determining the optimal position and shape of the route(s) may include the step of obtaining coverage area 220. Coverage area may represent the area of a real theater covered by a surveillance system consisting of, for example one or more sensors of various types.

According to some embodiments of the invention, determining the optimal position and shape of the route(s) may include the step of obtaining penetrator data 230. Penetrator data may represent penetrator properties and functionality such as speed, traversability, ability to cross slopes, the effect of roads on traversability and speed and the like. Penetrator speed may include the following: average speed; maximum speed and the like. Traversability may include the following: traversability threshold, indicating a level from which penetrator traversability is affected; traversability maximum threshold, indicating maximum traversability level, of which the penetrator progress can take place; traversability factor, indicating the effect of various types of terrain on penetrator speed and the like. Penetrator ability to cross slopes may include the following of: slopee threshold, indicating the terrain angle from which a penetrator traversability may be affected; slope maximum threshold, indicating the maximum terrain angle of which a penetrator progress may be affected; slope factor, indicating the effect a terrain angle may have on penetrator traversability and the like. The effect of roads on penetrator traversability may include a factor determining the effect a road may have on penetrator traversability and speed, and the like.

According to some embodiments of the invention, coverage area may he stored in the CASD system as a standard object-like table. Once the REM has fetched the GI data and the coverage area from the database of the CASD system 100, the method may include, for example, obtaining from the user inputs pertaining to a specific scenario, as schematically indicated by box 240. The user input may represent, for example, a target area, target points of interest, a friendly area and the like, using, for example, the SVM graphic simulator 166. The SVM graphic simulator 166 may provide the user a schematic 3D graphical representation of the area, and may provide a selection by the user of the exact point of view and points of interest needed for the scenario. The SVM simulator 166 may provide the user with a plurality of selections of view points. In an embodiment of the invention, the selections may be provided to the user either sequentially or simultaneously.

According to some embodiment of the invention, an asset may be defined on the planning map as an object that need to be protected from a penetrator (or intruder) at all costs. An intruder arrival to an asset may be regarded as “mission lost”.

According to some embodiment of the invention, a route from the asset to the penetrator may be computed in a similar manner of the opposite direction. Thus, the present invention further provides a tool for planning the arrival to a penetration scene.

According to some embodiments of the invention, determining the optimal position and shape of the route(s) may include, for example, obtaining design constraints that must be met for each scenario, as schematically indicated by box 250. Such constraints may include, for example, the maximum duration within which a penetrator may cross any part of a penetrating route, the maximum duration within which a penetrator may spend inside a coverage area, and the like. Once the user provided all the necessary inputs, the method may include, according to some embodiments of the invention, the generating of a penetrating route, which schematically indicated by box 310. A penetrating route may be associated with its corresponding points of interest, such as, for example, origin and target areas. In the event a plurality of penetrating routes are schematically displayed, each route may be distinguished by different corresponding distinct graphical means such as, for example, different colors, different marking types and the like. Once the penetrating route(s) are evaluated, REM selects only the routes that meet user constraints 340.

According to some embodiments of the invention, the CASD system 100 enables projecting a penetrating route onto an image of the real terrain and generating a graphical simulation, as schematically indicated by box 350. Such images can be of various types and of different sources, including but not limited to, aerial photo images, orthophoto images, satellite photo images and the like. Such images may be displayed using a graphical interface, such as a monitor, LCD screen and the like, as schematically indicated by box 410.

According to some embodiments of the invention, the CASD system 100 enables the user to change any the parameters pertaining to the design of a scenario heuristically, in order to achieve his/her targets and/or meet specified constraints using e.g., SVM module 166. The SVM module 166 may enable generating a 3D view of the area, thereby allowing an illustration of the actual recommended alternative route (s). Furthermore, the recommended alternatives can be exclusively inspected using a virtual 3D environment. As indicated by box 420, a simulation can be completed at any stage. Once one or more of the evaluated routes are approved, a graphical simulation and reports may be generated (430) and displayed using said graphical interface (410).

According to some embodiments of the invention, the CASD system 100 enables the issuing of reports, which may include, for example, recommendations regarding routes shape and position. These reports can be generated, for example, in an HTML file format, in an XML format, in a spreadsheet formal, as a CAD report, as GIS type reports, in a GI image format or in any other suitable format.

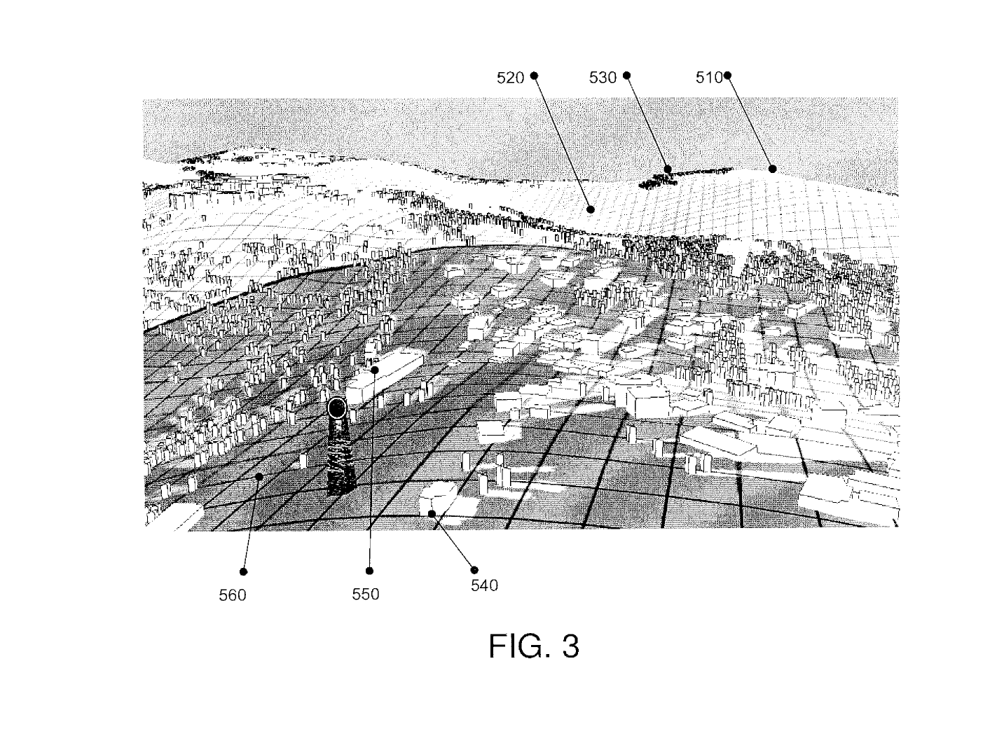

Reference is now made to FIG. 3. As already mentioned above, simulation may start with the pre-processing stage in which the entire area is partitioned to multiple area cells. Then, an iterative process is applied in which the highest point in each area cell is determined in view of its adjacent area cells. Thus a map containing the highest points is prepared. Similarly a map containing the obscured areas may also be prepared.

Site data may represent different types of terrain properties and/or construction entities and the like. Terrain properties can be of various types, such as, for example, hills 510, a valley 520 or trees 530. Construction entities describe all existing buildings within the area 540 and any construction planned to be built in the future 550. Furthermore, a coverage area may be supplied 560. The coverage area may be the result of an external system simulation, by prior computation in the pre-processing stage, or by a manual selection of closed curved areas and the like. The coverage area may represent a secured area, monitored by a surveillance system, and the like.

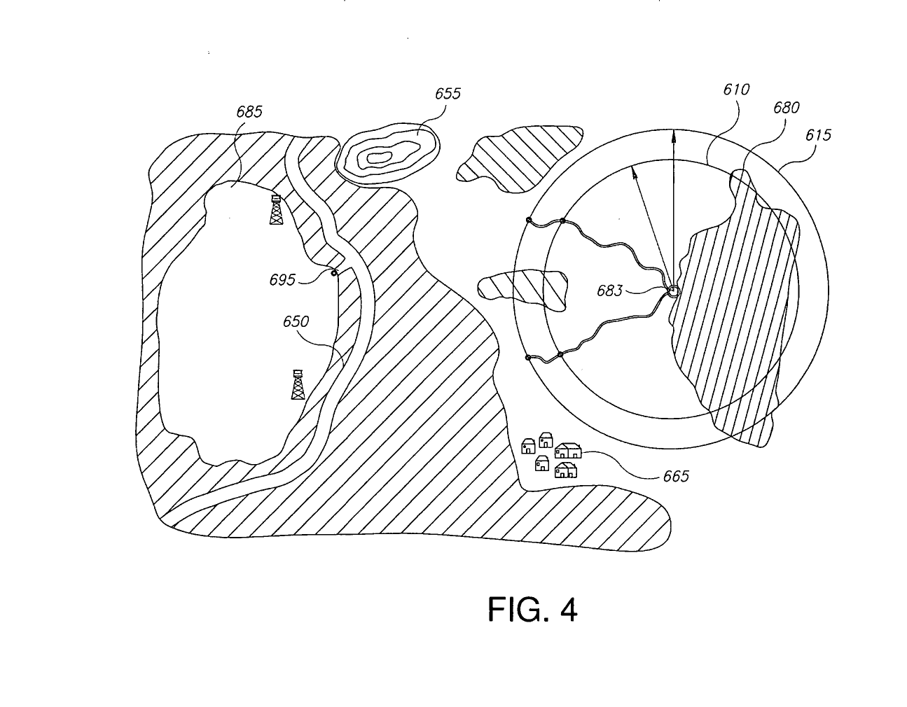

Reference is now made to FIG. 4. As already mentioned above, REM evaluates penetrating routes, using the algorithm of bubble expansion. The following is an example of the evaluation of penetrating routes using said algorithm. In order to calculate penetrating route(s), the user may define areas of interest. Areas of interest may include: origin area, indicating the area from which a penetrator nay start his move; destination area, indicating the area to which a penetrator may want to arrive; other areas on the way, indicating friendly areas that a penetrator would like to pass through and the like. In addition, the system may be queried for route estimation of a penetrator with or without roads.

An area can generally denote any one or any combination of the following: a closed curve surface, such as, for example, a polygon; an open curve; one ore more points and the like. A closed curve surface may be, for example, an enemy base, a village, an airport terminal and the like collateral fence. An open curve may be a border, an enemy front and the like. One or more points of interest may indicate gates, doors and the like. In our example, both origin area 680 and destination area 685 are placed. The example further includes terrain properties, such as a hill 655, houses 665, road 650, and coverage areas 690. The evaluation of route(s) process begins by REM creating a bubble around a point located within the origin area. As mentioned earlier, an origin point of interest may be selected. If such a point were selected, the bubble will be created around that point, wherein said point is located at the centre of the bubble. If no point were selected, the REM will systematically select a point located on the surface of the origin area, and create a small bubble centered at that point. During the process of generating alternative routes, REM may repeatedly select various points on the origin area systematically, in order to find the optimized penetrating route(s). If the origin area is a line, the REM will select a point located on that line. If the origin area is comprised of more than one point, REM will systematically select one of the points, and may repeatedly select other points, in order to find the optimized solution. In our example, REM selected an origin point 683 and a destination point 695. Once the bubble is created around the origin point 683, REM expands it in consecutive discrete steps, wherein the bubble radius in the next step is bigger than the radius of the bubble in the previous step, in one measuring constant. In our example the bubble 610 expanded in several consecutive steps and became 615. For each step, a scanning of the bubble surface is conducted, wherein each of the points on the bubble surface is virtually connected with one or more of the points selected in the previous step. When the bubble is just created, each of the points on the surface is virtually connected with the point selected originally to be the origin point, for example 683. Each of said virtual connections are checked and compared with scenario constraint. A scenario constraint may be, for example, that a route must always be placed on the terrain surface. If a connection were found to meet scenario constraint, continues curve connecting between the point found during the previous step and the new point located on the bubble surface, is generated. Each distinct continuum curve may be regarded as a potential penetrating route. In our example, two penetrating routes were evaluated. One penetrating route 625 was successfully evaluated, through bubble expansion. The other penetrating route 620, is currently evaluated by connecting a point on the bubble surface 615 to a route 620 through continues curve, which meets scenario constraints.

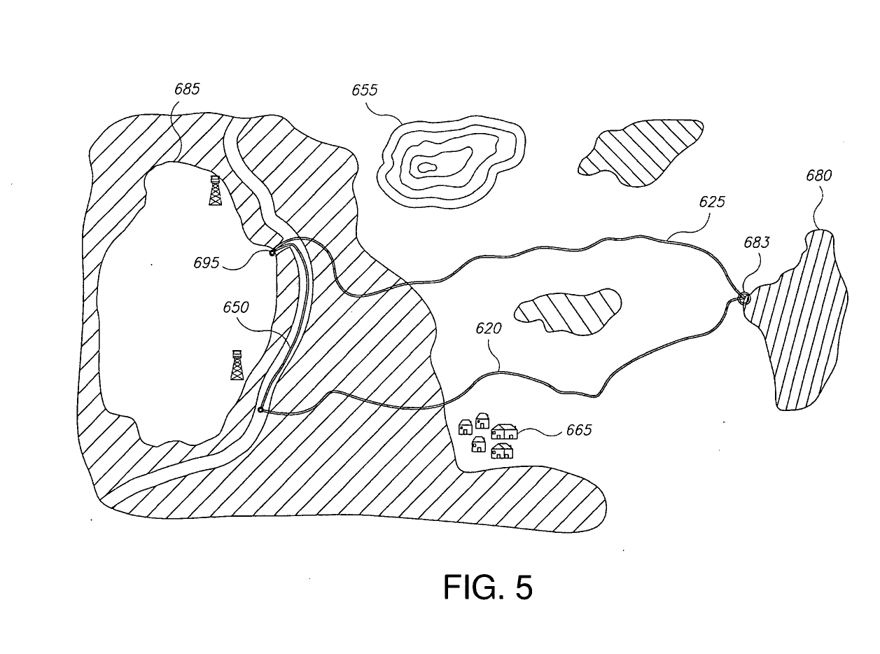

Reference is now made to FIG. 5. As described in FIG. 4. two different penetrating routes 620, 625 were evaluated, through the process of bubble expansion algorithm. Bubble expansion may be terminated when bubble surface is no longer congruent with destination area's surface. Once expansion is terminated, alternative routes may be compared. Each of the routes may be examined using REM, to see if it meets scenario constraints. Penetrating routes which meet scenario constraint may then be displayed on a graphical interface, and a simulation may be presented.

It should be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine may include, for example, any suitable processing platform, computing platform, computing device, processing device, computing system, processing system, computer, processor, or the like, and may be implemented using any suitable combination of hardware or software or both. The machine-readable medium or article may include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a rewritable DVD, a tape, a cassette, or the like. The instructions may include any suitable type of code, for example, an executable code, a compiled code, a dynamic code, a static code, interpreted code, a source code or the like, and may be implemented using any suitable high-level, low-level, object-oriented, visual, compiled or interpreted programming language. Such a compiled or interpreted programming language may be, for example, C, C++, C#, Net, Java, Pascal, MATLAB, BASIC, Cobol, Fortran, assembly language, machine code and the like.

It should be noted that embodiments of the invention may be used in a variety of applications. Examples of embodiments of the invention may include the usage of the invention in conjunction with many networks. Examples of such networks may include, without limitation, a wide area network (WAN), local area network (LAN), a global communication network, e.g., the Internet, a wireless communication network such as, for example, a wireless LAN (WLAN) communication network, a wireless virtual private network (VPN), a Bluetooth network, a cellular communication network, for example, a 3^{rd} Generation Partnership Project (3GPP), such as, for example, a Global System for Mobile communications (GSM) network, a Code Division Multiple Access (CDMA) communication network, a Wideband CDMA communication network, a Frequency Domain Duplexing (FDD) network, and the like.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it should be understood that alternatives, modifications, and variations of the present invention are to be construed as being within the scope of the appended claims.

What is claimed is:

1. A computerized method of providing a user with at least one scenario in a modeled theater, wherein said modeled theater include at least one threat area, at least one secured site, said method comprising:
a) providing at least one coverage area according to at least one scenario based one given threat area and secured area and predetermined constrain parameters;
b) providing at least one penetrator parameter; and
c) determining said at least one penetration scenario, the penetration scenario pertaining to at least one of the following: the position and shape of at least one penetrating route in the modeled theater;
wherein the determining said at least one scenario is accomplished based on computational analysis of at least one of the following data: geographical information data, gathered data, penetrator data, constraint data and user input data; and
wherein said computational analysis includes the evaluating of at least one penetrating route in the modeled theater.

2. The method of claim 1, comprising the step of schematically illustrating said at least one scenario on an output unit.

3. The method of claim 1 wherein said penetrating route consists of a continuum curve connecting at least one threat site with at least one secured site.

4. The method of claim 1 wherein said evaluation is accomplished based on the comparison between one or more penetrating routes with scenario constraints and user data and the prioritizing of said routes according to user specifications.

5. The method of claim 2, wherein at least one of said scenarios provides optimized penetrating route out of all possible scenarios that are determinable by taking into account said at least one constraint parameter.

6. The method of claim 1, wherein a plurality of scenarios is presented to the user in an order that corresponds to the penetrating route properties and scenario specifications provided by the user.

7. The method of claim 1, wherein said at least one scenario constraint parameter further indicates at least one of the following:
maximum duration, indicating the duration over which the secured site may be penetrated; preferred duration, indicating the preferred duration over which the secured site may be penetrated; maximum route length, indicating the maximum route length; preferred route length; maximum duration within covered area, indicating the duration over which a penetrator may spend within a covered area; preferred duration within covered area, indicating the preferred duration over which a penetrator may spend within a covered area.

8. The method of claim 1, wherein said at least one penetrator parameter further indicates at least one of the following: penetrator type; penetrator speed, indicating average and maximum speed; penetrator traversability, indicating the effecting magnitude of a traversability level on a given penetrator; penetrator maximum traversability threshold, indicating the maximum traversability threshold of a given penetrator; slope level, indicating the effecting magnitude of a slope level on a given penetrator; maximum slope level, indicating the maximum threshold of a slope for a given penetrator road factor, indicating the effecting magnitude of a road on the speed of a given penetrator.

9. The method of claim 1, wherein said computational analysis comprises at least one of the following: image analysis and geometrical analysis.

10. The method of claim 1, wherein at least two distinct weighing factors are assigned to at least two corresponding parameter constraints for determining the order according to which said at Least two parameter constraints are to be taken into consideration for determining said at least one constraint.

11. The method of claim 1, wherein an area is defined by one of the following: a closed curve; an open curve; one or more discrete points.

12. The method of claim 1, wherein a threat area is defined by the area from which a penetrating route may originate.

13. The method of claim 1, wherein a secured area is defined by the area to which a penetrating route may be destined.

14. The method of claim l, wherein a covered area is defined by the area covered by surveillance system.

15. The method of claim 1, wherein a penetrating route is defined by continuum curve generated through the progression simulation of a real object along said route in the real terrain within a certain time interval “t”, by means of a virtual object in the modeled theater

16. The method of claim 13, wherein a progression simulation is achieved through the expansion of a 3D bubble, centered at a threat site point.

17. The method of claim 13, wherein the continuum curve is comprised of one or more curves connecting between one point located on the bubble surface of the present state, and one point located on the bubble of the previous state, wherein the bubble of the first state is defined as a point located within threat site.

18. The method of claim 1, wherein said at Least one scenario is selectably viewable from various angles in a successive and simultaneous manner.

19. A data processing system for providing a user with at least one scenario in a modeled theater, wherein said modeled theater includes at least one threat area, at least one secured site, said system comprising:
a coverage analysis module configured to provide at least one coverage area according to at least one scenario based one given threat area and secured area and predetermined constrain parameters:
an input module for providing at least one penetrator parameter; and
a penetration analysis module configured to determine said at least one penetration scenario, the penetration scenario pertaining to at least one of the following: the position and shape of at least one penetrating route in the modeled theater;
wherein the determining of said at least one scenario is accomplished based on computational analysis of at least one of the following data: geographical information data, gathered data, penetrator data, constraint data and user input data; and
wherein said computational analysis includes the evaluating of at least one penetrating route in the modeled theater.
